(19) United States
(12) Patent Application Publication
(10) Pub. No.: US 2013/0209798 A1
(43) Pub. Date: Aug. 15, 2013

(54) DOUBLE-SIDED PRESSURE-SENSITIVE ADHESIVE TAPE

(71) Applicant: Nitto Denko Corporation, (US)

(72) Inventors: Masaaki SATOU, Osaka (JP); Toshihide SUZUKI, Osaka (JP); Naoki NAKAYAMA, Osaka (JP); Akinori TAMURA, Osaka (JP); Noboru YOSHIDA, Osaka (JP); Takahisa MIZUTORI, Osaka (JP)

(73) Assignee: NITTO DENKO CORPORATION, Osaka (JP)

(21) Appl. No.: 13/763,892

(22) Filed: Feb. 11, 2013

(30) Foreign Application Priority Data
Feb. 13, 2012 (JP) 2012-028476

(51) Int. Cl. C09J 133/02; C09J 133/10; C09J 7/02

(52) U.S. Cl. CPC C09J 133/02; C09J 7/0246; C09J 133/10
USPC 428/354

(57) ABSTRACT

A double-sided pressure-sensitive adhesive tape includes: a substrate; a first pressure-sensitive adhesive layer provided on one surface of the substrate; and a second pressure-sensitive adhesive layer provided on the other surface of the substrate. At least one of the first pressure-sensitive adhesive layer and the second pressure-sensitive adhesive layer contains both an acrylic polymer and an acrylic oligomer whose weight average molecular weight is 20000 or less and whose monomer is different from that of the acrylic polymer. The content of a tackifier for providing tackiness is less than 5% by mass. By containing the acrylic oligomer whose monomer is different from that of the acrylic polymer in at least one of the first pressure-sensitive adhesive layer and the second pressure-sensitive adhesive layer, the drop impact resistance in a low-temperature atmosphere is improved.

### BACKGROUND OF THE INVENTION

1. Field of the Invention

The present invention relates to a double-sided pressure-sensitive adhesive tape, and more specifically, to a double-sided pressure-sensitive adhesive tape to be used for fixing members of electronic devices.

2. Description of the Related Art

In both mobile electronic devices, such as mobile phones, PHSs, digital cameras, electronic notebooks, mobile music players, mobile game machines, smart phones, and tablet personal computers, and electronic devices, such as displays for television sets and personal computers, double-sided pressure-sensitive adhesive tapes are used for adhesively fixing various members or modules including: joining between a display (also, referred to as a window, lens, panel, display panel, transparent member of a display, or the like) to be provided on the surface of an image display module and a case; joining between touch panel members; and joining between LCD members.

When an electronic device is placed under a low-temperature atmosphere, there are many cases where the pressure-sensitive adhesive property of a double-sided pressure-sensitive adhesive tape is decreased. Accordingly, there is the problem that, when such a device is placed under a low-temperature atmosphere for a long period of time, or when such a device is dropped during the use thereof at a low-temperature atmosphere, the adhesion between a display and a case becomes weak, thereby causing the display to easily peel off or slip from the case.

### PATENT DOCUMENT

[Patent Document 1] Japanese Patent Application Publication No. 2009-215355

However, in conventional double-sided pressure-sensitive adhesive tapes to be used for fixing components of electronic devices, the impact resistance under a low-temperature atmosphere has not been taken into consideration. For example, Patent Document 1 discloses a double-sided pressure-sensitive adhesive tape to be used for fixing components of electronic devices. However, in this double-sided pressure-sensitive adhesive tape, the impact resistance under a low-temperature atmosphere has not been taken into consideration.

### SUMMARY OF THE INVENTION

Therefore, a purpose of the present invention is to provide a double-sided pressure-sensitive adhesive tape in which a decrease in impact resistance can be suppressed even when the tape is used under a low-temperature atmosphere.

An embodiment of the present invention is a double-sided pressure-sensitive adhesive tape. The double-sided pressure-sensitive adhesive tape is used for fixing members of an electronic device, and comprises: a substrate; a first pressure-sensitive adhesive layer provided on one surface of the substrate; and a second pressure-sensitive adhesive layer provided on the other surface of the substrate. At least one of the first pressure-sensitive adhesive layer and the second pressure-sensitive adhesive layer contains both an acrylic polymer and an acrylic oligomer whose weight average molecular weight is 20000 or less and whose monomer is different from that of the acrylic polymer.

In the double-sided pressure-sensitive adhesive tape according to the aforementioned embodiment, the content of a tackifier in at least one of the first pressure-sensitive adhesive layer and the second pressure-sensitive adhesive layer may be less than 5%. In addition, the thickness of the substrate may be 5 to 20% relative to that of the double-sided pressure-sensitive adhesive tape. In addition, the content of the acrylic oligomer may be 1 to 50 parts by mass. In addition, the substrate may be a plastic film.

A double-sided pressure-sensitive adhesive tape in which the respective components described above are appropriately combined can be encompassed in the scope of the invention for which protection is sought by this application.

### BRIEF DESCRIPTION OF THE DRAWINGS

Embodiments will now be described, by way of example only, with reference to the accompanying drawings, which are meant to be exemplary, not limiting, and wherein like elements are numbered alike in several figures, in which:

FIG. 1 is a schematic sectional view illustrating the structure of a double-sided pressure-sensitive adhesive tape according to an embodiment;

FIGS. 2A and 2B are schematic views of an evaluation sample to be used in evaluating impact resistance, in which: FIG. 2A is a a plan view of the evaluation sample; and FIG. 2B is a sectional view, taken along Y-Y Line in FIG. 2A; and

FIGS. 3A and 3B are schematic views of an evaluation sample to be used when level-difference followability (waterproof property) is evaluated, in which: FIG. 3A is a plan view of the evaluation sample; and FIG. 3B is a sectional view, taken along Z-Z Line in FIG. 3A.

### DETAILED DESCRIPTION OF THE INVENTION

The invention will now be described by reference to the preferred embodiments. This does not intend to limit the scope of the present invention, but to exemplify the invention.

Hereinafter, the present invention will be described with reference to the drawings based on the preferred embodiments of the invention. The preferred embodiments do not intend to limit the scope of the invention but exemplify the invention. All of the features and the combinations thereof described in the embodiments are not necessarily essential to the invention.

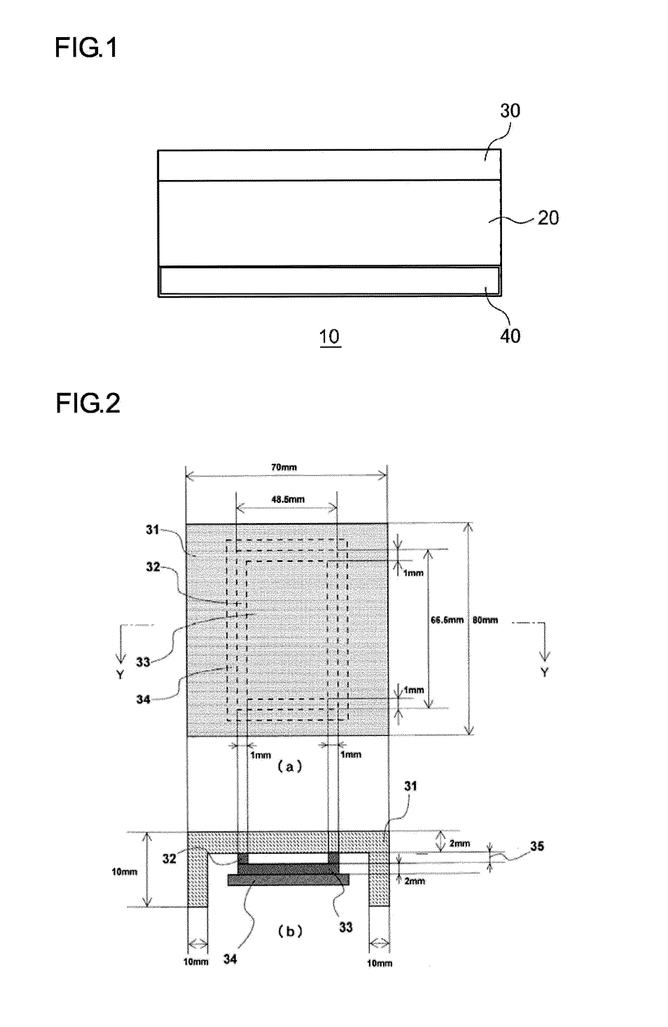

FIG. 1 is a schematic sectional view illustrating the structure of a double-sided pressure-sensitive adhesive tape 10 according to an embodiment. As illustrated in FIG. 1, the double-sided pressure-sensitive adhesive tape 10 according to the present embodiment comprises: a substrate 20; a first pressure-sensitive adhesive layer 30 provided on one surface of the substrate 20; and a second pressure-sensitive adhesive layer 40 provided on the other surface of the substrate 20. At least one of the first pressure-sensitive adhesive layer 30 and the second pressure-sensitive adhesive layer 40 contains both an acrylic polymer and an acrylic oligomer whose weight average molecular weight is 20000 or less and whose monomer is different from that of the acrylic polymer. The double-sided pressure-sensitive adhesive tape 10 can be preferably used for fixing members of electronic devices. Hereinafter, at least one of the first pressure-sensitive adhesive layer 30 and the second pressure-sensitive adhesive layer 40 may be simply referred to as a “pressure-sensitive adhesive layer”.

Hereinafter, the double-sided pressure-sensitive adhesive tape 10 will be described in detail. An acrylic polymer and an acrylic oligomer, which are essential components for the pressure-sensitive adhesive layer, and a cross-linking agent and a tackifier, which are optional components, will be first described, and the substrate 20 and a non-illustrated separator will be then described, and a method of manufacturing the double-sided pressure-sensitive adhesive tape 10 will be further described.

### [Acrylic Polymer]

An acrylic pressure-sensitive adhesive composition that forms the pressure-sensitive adhesive layer may have any form, and, for example, an emulsion-type pressure-sensitive adhesive, a solvent-type pressure-sensitive adhesive, a solvent-less type pressure-sensitive adhesive (UV curable pressure-sensitive adhesive), and a thermal fusion-type pressure-sensitive adhesive (hot melt-type pressure-sensitive adhesive), etc., can be used.

The acrylic pressure-sensitive adhesive composition that forms the pressure-sensitive adhesive layer is not particularly limited, but, for example, a composition whose base polymer is an acrylic polymer can be used, the acrylic polymer containing, as an essential monomer component (monomer major component), (meth)acrylic acid alkyl ester and being produced, if necessary, by polymerizing a copolymerizable monomer that can be copolymerized with the monomer component. Examples of the copolymerizable monomer include, for example, a polar group-containing monomer and a polyfunctional monomer, etc., which will be described later. Examples of the polymerization method are not particularly limited, but conventionally and publicly known methods, such as a UV polymerizing method, solution polymerization method, and emulsion polymerization method, can be used. Herein, the (meth)acrylic acid alkyl ester means an acrylic acid alkyl ester and/or a methacrylic acid alkyl ester. Hereinafter, all of the “(meth).” expressions have the same meaning.

The (meth)acrylic acid alkyl ester to be used as a monomer major component of the aforementioned acrylic polymer is, for example, a (meth) acrylic acid alkyl ester having a linear or branched alkyl group. Examples of the (meth)acrylic acid alkyl ester include (meth) acrylic acid C1-C20 alkyl esters, preferably (meth)acrylic acid C2-C14 alkyl esters, and more preferably (meth)acrylic acid C2-C10 alkyl esters, such as (meth)acrylic acid methyl, (meth) acrylic acid ethyl, (meth) acrylic acid propyl, (meth)acrylic acid isopropyl, (meth)acrylic acid butyl, (meth)acrylic acid isobutyl, (meth)acrylic acid s-butyl, (meth)acrylic acid t-butyl, (meth)acrylic acid pentyl, (meth)acrylic acid isopentyl, (meth)acrylic acid hexyl, (meth)acrylic acid heptyl, (meth)acrylic acid octyl, (meth)acrylic acid 2-ethylhexyl, (meth)acrylic acid isooctyl, (meth)acrylic acid nonyl, (meth)acrylic acid isononyl, (meth)acrylic acid decyl, (meth)acrylic acid isodecyl, (meth)acrylic acid undecyl, (meth)acrylic acid dodecyl, (meth)acrylic acid tridecyl, (meth)acrylic acid tetradecyl, (meth)acrylic acid pentadecyl, (meth)acrylic acid hexadecyl, (meth)acrylic acid heptadecyl, (meth)acrylic acid octadecyl, (meth)acrylic acid nonadecyl, and (meth)acrylic acid eicosyl.

The ratio of the (meth)acrylic acid alkyl ester is, for example, preferably 60% by mass or more, and more preferably 80% by mass or more, based on the total mass of the monomer components for preparing the acrylic polymer.

The aforementioned acrylic polymer may contain, as a monomer component, various copolymerizable monomers, such as a polar group-containing monomer and a polyfunctional monomer. By using a copolymerizable monomer as a monomer component, for example, adhesive force to an adherend can be improved, or the cohesive force of the pressure-sensitive adhesive can be enhanced. The copolymerizable monomer can be used alone or in combination with two or more thereof.

Examples of the polar group-containing monomer include, for example: carboxyl group-containing monomers such as (meth)acrylic acid, itaconic acid, maleic acid, fumaric acid, crotonic acid, and isocrotonic acid or their anhydrides (maleic anhydride, etc.); hydroxyl group-containing monomers, such as (meth)acrylic acid hydroxyalkyls including (meth)acrylic acid hydroxyethyl, (meth)acrylic acid hydroxypropyl, and (meth)acrylic acid hydroxybutyl; amido-group containing monomers, such as acrylamide, (meth)acrylamide, N,N-dimethyl(meth)acrylamide, N-methylol(meth)acrylamide, N-methoxymethyl(meth)acrylamide, and N-butoxymethyl(meth)acrylamide; amino group-containing monomers, such as (meth)acrylic acid aminoethyl, (meth)acrylic acid dimethylaminoethyl, and (meth)acrylic acid t-butylaminoethyl; glycidyl group-containing monomers, such as (meth)acrylic acid glycidyl and (meth)acrylic acid methylglycidyl; cyano group-containing monomers, such as acrylonitrile and methacrylonitrile; heterocycle-containing vinyl monomers, such as N-vinyl-2-pyrrolidone, (meth)acryloyl morpholine, N-vinylpyridine, N-vinylpiperidon, N-vinylpyrimidine, N-vinylpiperazine, N-vinylpyrrole, N-vinylimidazole, and N-vinyloxazole; (meth)acrylic acid alkoxyalkyl monomers, such as (meth) acrylic acid methoxyethyl and (meth)acrylic acid ethoxyethyl; sulfonate group-containing monomers, such as vinyl sulfonate sodium; phosphate group-containing monomers, such as 2-hydroxyethyl acryloyl phosphate; imide group-containing monomers, such as cyclohexyl maleimide and isopropyl maleimide; and isocyanate group-containing monomers, such as 2-methacryloyloxyethyl isocyanate, etc.

Carboxyl group-containing monomers, such as acrylic acid, or anhydrides thereof can be preferably used as the polar group-containing monomer. The use amount of the polar group-containing monomer is preferably 1 to 30% by mass, and more preferably 1 to 15% by mass, based on the total mass of the monomer components for forming the acrylic polymer. By making the use amount of the polar group-containing monomer to be 30% by mass or less based on the total mass of the monomer components for forming the acrylic polymer, it can be avoided that the cohesive force of the acrylic pressure-sensitive adhesive composition may become too large and it can be suppressed that the adhesiveness of the pressure-sensitive adhesive layer may be decreased. In addition, by making the use amount thereof to be 1% by mass or more based on the total mass of the monomer components for forming the acrylic polymer, it can be avoided that the cohesive force of the acrylic pressure-sensitive adhesive composition may become too small and good shearing force can be provided to the pressure-sensitive adhesive layer.

Examples of the polyfunctional monomer include, for example: hexanediol di(meth)acrylate, butandiol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl(meth)acrylate, vinyl(meth)acrylate, divinylbenzene, epoxy acrylate, polyester acrylate, and urethane acrylate, etc.

The use amount of the polyfunctional monomer is preferably 2% by mass or less based on the total mass of the monomer components for preparing the acrylic polymer. The use amount thereof is, for example, 0.01 to 2% by mass, and preferably 0.02 to 1% by mass, based on the total mass of the monomer components for preparing the acrylic polymer. By making the use amount of the polyfunctional monomer to be 2% by mass or less based on the total mass of the monomer components for preparing the acrylic polymer, it can avoided that the cohesive force of the acrylic pressure-sensitive adhesive composition may become too large and it can be suppressed that the adhesiveness of the pressure-sensitive adhesive layer may be decreased. In addition, by making the use amount thereof to be 0.01% by mass or more based on the total mass of the monomer components for preparing the acrylic polymer, it can be suppressed that the cohesive force of the acrylic pressure-sensitive adhesive composition may be decreased.

As the copolymerizable monomer, in addition to the aforementioned polar group-containing monomers and polyfunctional monomers, for example, vinyl esters, such as vinyl acetate and vinyl propionate; aromatic vinyl compounds, such as styrene, α-methylstyrene, and vinyl toluene; (meth)acrylic acid esters of cyclic alcohols, such as cyclopentyl(meth)acrylate, cyclohexyl(meth)acrylate, and isobornyl(meth)acrylate; ethylenically unsaturated monomers, such as (meth)acrylonitrile, N-(meth)acryloyl morpholine, and N-vinyl-2-pyrrolidone; olefins or dienes, such as ethylene, butadiene, isoprene, and isobutylene; and vinyl ethers, such as vinyl alkyl ether, can be used.

### [Acrylic Oligomer]

The double-sided pressure-sensitive adhesive tape 10 according to the embodiment contains, as an additive, an acrylic oligomer whose monomer is different from that of the aforementioned acrylic polymer. An acrylic oligomer is a polymer whose weight average molecular weight is smaller than that of an acrylic polymer.

The addition amount of the acrylic oligomer is preferably 1 to 50 parts by mass, more preferably 2 to 40 parts by mass, 3 to 30 parts by mass, and 4 to 20 parts by mass, and most preferably 5 to 15 parts by mass, based on 100 parts by mass of the acrylic polymer. By making the content of the oligomer to be within this range, the drop impact resistance of the double-sided pressure-sensitive adhesive tape 10 in a low-temperature atmosphere can be improved.

It is desirable that the glass transition temperature (Tg) of the acrylic oligomer is 120° C. or lower, preferably 110° C. or lower, and more preferably 100° C. or lower. Thereby, the drop impact resistance thereof in a low-temperature atmosphere can be further improved.

The weight average molecular weight of the acrylic oligomer is preferably 2000 to 20000, more preferably 2500 to 15000, and most preferably 3000 to 10000. Thereby, the drop impact resistance thereof in a low-temperature atmosphere can be further improved.

The weight average molecular weight of the acrylic polymer or the acrylic oligomer can be determined by polystyrene conversion with the use of a GPC method. Specifically, the weight average molecular weight can be measured by using the HPLC 8020 made by TOSOH CORPORATION and two TSKgelGMH-H (20) columns and in a condition in which the flow rate of tetrahydrofuran solvent is 0.5 ml/min.

### <Method of Producing Acrylic Oligomer>

The acrylic oligomer can be produced, for example, by polymerizing (meth) acrylic acid ester with the use of a solution polymerization method, bulk polymerization method, emulsion polymerization method, suspension polymerization, block polymerization, or the like.

Examples of such a (meth)acrylic acid ester include: (meth)acrylic acid alkyl esters, such as (meth)acrylic acid methyl, (meth)acrylic acid ethyl, (meth)acrylic acid propyl, (meth)acrylic acid butyl, (meth)acrylic acid isobutyl, (meth)acrylic acid pentyl, (meth)acrylic acid hexyl, (meth)acrylic acid-2-ethylhexyl, (meth)acrylic acid octyl, (meth)acrylic acid nonyl, (meth)acrylic acid decyl, and (meth)acrylic acid dodecyl; esters of (meth)acrylic acids with alicyclic alcohols, such as cyclohexyl(meth)acrylate and (meth)acrylic acid isobornyl; and (meth)acrylic acid aryl esters, such as (meth)acrylic acid phenyl and (meth)acrylic acid benzyl. These (meth)acrylic acid ester can be used alone or in combination.

As the monomer unit that forms the acrylic oligomer, cyclohexyl methacrylate can be preferably used.

Alternatively, the acrylic oligomer can also be obtained by copolymerizing a monomer having a polymerizable unsaturated bond that is copolymerizable with the (meth)acrylic acid ester, in addition to the aforementioned (meth)acrylic acid ester component unit.

Examples of the monomer having a polymerizable unsaturated bond that is copolymerizable with the (meth)acrylic acid ester include: (meth)acrylic acid alkoxyalkyls, such as (meth)acrylic acid, (meth)acrylic acid methoxyethyl, (meth)acrylic acid ethoxyethyl, (meth) acrylic acid propoxyethyl, (meth)acrylic acid butoxyethyl, and (meth)acrylic acid ethoxypropyl; salts, such as alkali metal (meth)acrylate; di(meth)acrylic acid esters of (poly)alkylene glycols, such as di(meth)acrylic acid ester of ethylene glycol, di(meth)acrylic acid ester of diethylene glycol, di(meth)acrylic acid ester of triethylene glycol, di(meth)acrylic acid ester of polyethylene glycol, di(meth)acrylic acid ester of propylene glycol, di(meth)acrylic acid ester of dipropylene glycol, and di(meth)acrylic acid ester of tripropylene glycol; poly(meth)acrylic acid esters, such as trimethylolpropane tri(meth)acrylic acid ester; (meth)acrylonitrile; vinyl acetate; vinylidene chloride; halogenated vinyl compounds, such as (meth) acrylic acid-2-chloroethyl; oxazoline group-containing polymerizable compounds, such as 2-vinyl-2-oxazoline, 2-vinyl-5-methyl-2-oxazoline, and 2-isopropenyl-2-oxazoline; aziridine group-containing polymerizable compounds, such as (meth) acryloylaziridine and (meth)acrylic acid-2-aziridinylethyl; epoxy group-containing vinyl monomers, such as allyl glycidyl ether, (meth)acrylic acid glycidyl ester, and (meth)acrylic acid-2-ethyl glycidyl ester; hydroxyl group-containing vinyl monomers, such as (meth)acrylic acid-2-hydroxyethyl, (meth)acrylic acid-2-hydroxypropyl, monoesters of (meth)acrylic acids with polypropylene glycol or polyethylene glycol, and adducts of lactones with (meth)acrylic acid-2-hydroxyethyl; fluorine-containing vinyl monomers, such as fluorine-substituted (meth)acrylic acid alkyl ester; unsaturated carboxylic acids, such as itaconic acid, crotonic acid, maleic acid, and fumaric acid, salts of these unsaturated carboxylic acids, (partial) ester compounds thereof, and acid anhydrides thereof; reactive halogen-containing vinyl monomers, such as 2-chloroethyl vinyl ether and monochloro vinyl acetate; amide group-containing vinyl monomers, such as methacrylamide, N-methylol methacrylamide, N-methoxyethyl methacrylamide, N-butoxymethyl methacrylamide, and N-acryloyl morpholine; organic silicon-containing vinyl monomers, such as vinyltrimethoxysilane, γ-methacryloxpropyl trimethoxy silane, allyltrimethoxysilane, trimethoxysilylpropylallylamine, and 2-methoxy ethoxy trimethoxy silane; and macro-monomers having a radically polymerizable vinyl group at the monomer end to which a vinyl group has been polymerized. These monomer may be copolymerized, alone or in combination, with the aforementioned (meth)acrylic acid ester.

In the double-sided pressure-sensitive adhesive tape 10 according to the present embodiment, for example, a copolymer of cyclohexyl methacrylate (CHMA) and isobutyl methacrylate (IBMA), that of cyclohexyl methacrylate (CHMA) and isobornyl methacrylate (IBXMA), that of cyclohexyl methacrylate (CHMA) and acryloyl morpholine (ACMO), and that of cyclohexyl methacrylate (CHMA) and diethylacrylamide (DEAA) are preferable as the acrylic oligomer that forms the pressure-sensitive adhesive layer, from the viewpoint that a double-sided pressure-sensitive adhesive tape, excellent in the adhesiveness to an adherend having low polarity, such as polystyrene, can be provided.

Regarding the composition ratio of the copolymer that forms the acrylic oligomer, the content of cyclohexyl methacrylate (CHMA) is 50 to 85% by mass, and preferably 55 to 75% by mass; and that of isobutyl methacrylate (IBMA), isobornyl methacrylate (IBXMA), acryloyl morpholine (ACMO), or diethylacrylamide (DEAA) is 15 to 50% by mass, and preferably 25 to 45% by mass.

A functional group reactive with an epoxy group or an isocyanate group may be further introduced into the acrylic polymer. Examples of such a functional group include a hydroxyl group, carboxyl group, amino group, amide group, and a mercapto group. When the acrylic oligomer is produced, it is preferable to use a monomer having such a functional group.

### <Method of Adjusting Molecular Weight of Acrylic Oligomer>

In order to adjust the molecular weight of the acrylic oligomer, a chain transfer agent can be used while the acrylic oligomer is being polymerized. Examples of a chain transfer agent to be used include: compounds having a mercapto group, such as octylmercaptan, dodecyl mercaptan, and t-dodecyl mercaptan; thioglycolic acid, ethyl thioglycolate, propyl thioglycolate, butyl thioglycolate, t-butyl thioglycolate, 2-ethylhexyl thioglycolate, octyl thioglycolate, decyl thioglycolate, dodecyl thioglycolate, thioglycolic acid ester of ethylene glycol, thioglycolic acid ester of neopentyl glycol, and thioglycolic acid ester of pentaerythritol. Among them, thioglycolic acids can be preferably used.

The use amount of the chain transfer agent is not particularly limited, but the chain transfer agent is usually contained in an amount within a range of 0.1 to 20 parts by mass, preferably within a range of 0.2 to 15 parts by mass, and more preferably within a range of 0.3 to 10 parts by mass, based on 100 parts by mass of the acrylic monomer. By adjusting the addition amount of the chain transfer agent, as stated above, an acrylic oligomer having a preferred molecular weight can be obtained.

### [Cross-Linking Agent]

In order to adjust the cohesive force, a cross-linking agent may be added to the pressure-sensitive adhesive composition that forms the pressure-sensitive adhesive layer of the double-sided pressure-sensitive adhesive tape 10. The cross-linking agent is not particularly limited, but conventionally and publicly known cross-linking agents can be used. Examples of the cross-linking agent include, for example: epoxy cross-linking agents, such as polyethylene glycol diglycidyl ether; isocyanate cross-linking agents; oxazoline cross-linking agents; aziridine cross-linking agents; hydrophilized carbodiimide cross-linking agents; active methylol; active alkoxy methyl; metal chelate cross-linking agents; and silane coupling agents, etc. These cross-linking agents can be used alone or in combination with two or more thereof. The use amount of the cross-linking agent is usually 0.001 to 10 parts by mass, and preferably 0.001 to 5 parts by mass, based on 100 parts by mass of the polymer.

### [Tackifier]

A tackifier may be contained in the aforementioned pressure-sensitive adhesive composition. In the present specification, the aforementioned acrylic oligomer is not contained in the tackifier.

As such the tackifier, one or more of tackifiers selected from various tackifying resins, such as, for example, rosin resins, rosin derivative resins, petroleum resins, terpene resins, phenol resins, and ketone resins. The content of the tackifier is less than 10% by mass, preferably less than 5% by mass, more preferably less than 3% by mass, and most preferably less than 1% by mass, based on 100% by mass of the acrylic polymer. By making the content of the tackifier in the pressure-sensitive adhesive composition to be within this range, the drop impact resistance of the double-sided pressure-sensitive adhesive tape in a low-temperature atmosphere can be effectively maintained.

### [Substrate]

Examples of the substrate 20 (also, referred to as a non-releasable sheet-shaped substrate) include, for example: plastic films made of a plastic, such as a polyolefin resin including polyethylene, etc., polyester resin including polyethylene terephthalate, etc., vinyl acetate resin, polyimide resin, fluorine resin, cellophane, or the like; non-woven cloth formed of rayon, polyester, and polyurethane; paper, such as craft paper and Japanese paper; rubber sheets made of natural rubber, butyl rubber, or the like; foamed sheets formed by foaming polyurethane, polychloroprene rubber, or the like; metallic foils, such as aluminum foil and copper foil; and complexes of these materials. Alternatively, one or both surfaces of each of these materials may be subjected to a surface treatment, such as a corona treatment. It is preferable to use a plastic film as the substrate 20, from the viewpoints of workability and cost.

In addition, it is preferable that at least the surface of the substrate 20 is colored, for example, black, gray, white, blue, red, green, or the like. Among them, it is more preferable that at least the surface thereof is colored black.

In electronic devices, there are many cases where a transparent display is fixed to a case that is colored black, or the like. When a pressure-sensitive adhesive is coated on a substrate, as described later, the double-sided pressure-sensitive adhesive tape looks black, or the like, when the pressure-sensitive adhesive is transparent. Accordingly, when the substrate 20 of a double-sided pressure-sensitive adhesive tape for fixing a transparent display to a case is colored black in the same way as the case, the design of an electronic device can be improved.

The aforementioned “at least the surface is colored” means that the appearance of the substrate 20 is colored black, or the like. That is, even the case where a transparent layer is coated on a substrate whose surface is colored black is included in the aforementioned “at least the surface is colored”.

Examples of a black colorant to be used for coloring the substrate 20 black include, for example: carbon black (furnace black, channel black, acetylene black, thermal black, and lamp black, etc.), graphite, copper oxide, manganese dioxide, aniline black, perylene black, titanium black, cyanine black, activated carbon, ferrite (non-magnetic ferrite, magnetic ferrite, etc.), magnetite, chrome oxide, iron oxide, molybdenum disulfide, chromium complex, complex oxide black pigment, and anthraquinone organic black pigment, etc. Among them, carbon black is preferable from the viewpoints of cost and availability.

The use amount of the colorant is not particularly limited, but an appropriate amount thereof is used in which a desired optical property is obtained in the double-sided pressure-sensitive adhesive tape 10 according to the present embodiment. A method of coloring the substrate 20 may be one in which the substrate 20 is colored by containing, as a colorant, a filler, pigment, dye, or the like, into the thermoplastic film that forms the substrate 20; or may be one in which the surface of the thermoplastic film is printed with color, such as black. Alternatively, the double-sided pressure-sensitive adhesive tape 10 may be colored by using a colorant for the filler, pigment, dye, or the like, in the pressure-sensitive adhesive layer.

### [Separator]

Examples of the separator (also, referred to as a releasable sheet-shaped substrate) include, for example: glassine paper, craft paper, clay-coated paper, paper on which a film made of polyethylene, etc., is laminated, paper on which a resin, such as polyvinyl alcohol, acrylic acid ester copolymer, or the like, is laminated, and a material in which a fluorine resin, silicone resin, or the like, which is a remover, is coated on a synthetic resin film made of polyester, polypropylene, or the like. However, the separator is not particularly limited.

When the separator is laminated on the pressure-sensitive adhesive layer of the double-sided pressure-sensitive adhesive tape 10, it is preferable, for the improvement of the workability, to select the respective separators to be laminated on both surfaces of the pressure-sensitive adhesive layer such that the peel force of one of the separators is different from that of the other separator. The workability is improved when the separators are selected, for example, as follows: the peel force of the separator to be first attached to one surface of the double-sided pressure-sensitive adhesive tape is smaller than that of the separator to be subsequently attached to the other surface thereof.

### <Method of Manufacturing Double-Sided Pressure-Sensitive Adhesive Tape>

The double-sided pressure-sensitive adhesive tape 10 according to the embodiment can be obtained by various methods. For example, it can be obtained by coating a pressure-sensitive adhesive solution on one surface of the substrate 20 to be dried and then by laminating a separator on the surface of the formed pressure-sensitive adhesive layer. Alternatively, it can also be obtained by coating a pressure-sensitive adhesive solution on a separator to be dried and then by laminating the substrate 20 on the surface of the formed pressure-sensitive adhesive layer.

A coating applicator to be used in coating pressure-sensitive adhesive on various sheet-shaped substrate 20 is a usually used one and is not particularly limited. Examples of the coating applicator include, for example, a roll knife coater, die coater, roll coater, bar coater, gravure roll coater, reverse roll coater, dipping, and blade coater, etc.

A drying condition is not particularly limited, as long as: a solvent in a pressure-sensitive adhesive solution and a remaining monomer are dried and removed while being dried; and a cross-linked structure can be formed with a functional group contained in the acrylic polymer reacting with a cross-linking agent. For example, a drying condition is preferably 60 to 120° C. for 1 to 5 minutes, but not limited thereto. After the drying, the pressure-sensitive adhesive layer is aged in a state of being sandwiched by the substrates 20, thereby allowing the cross-linking reaction to be further advanced.

The double-sided pressure-sensitive adhesive tape 10 according to the embodiment can be provided in a roll shape or a sheet shape. Further, the tape 10 can be processed into various shapes.

The thickness (total thickness) of the double-sided pressure-sensitive adhesive tape 10 is preferably 100 to 300 μm, and more preferably 100 to 200 μm. In addition, the thickness of the substrate 20 is preferably 5 to 20%, and more preferably 5 to 15%, relative to the thickness of the double-sided pressure-sensitive adhesive tape 10. By making the ratio of the thickness of the substrate to that of the double-sided pressure-sensitive adhesive tape to be within this range, blocking occurrence time, workability, and level-difference followability (waterproof property) can be maintained.

The double-sided pressure-sensitive adhesive tape 10 according to the embodiment may be used in a state of being formed into a frame shape (window frame shape). In the double-sided pressure-sensitive adhesive tape 10 formed into a frame shape, the adhesion area is small, and hence there are sometimes the cases where the fixed state between a case and a display cannot be maintained, particularly when the pressure-sensitive adhesive force of the tape 10 is decreased in a low-temperature atmosphere. However, with the double-sided pressure-sensitive adhesive tape 10 according to the embodiment, the pressure-sensitive adhesive force and the drop impact resistance at a low-temperature atmosphere can be maintained even when the tape 10 is formed into a frame shape.

In both mobile electronic devices, such as mobile phones, PHSs, digital cameras, electronic notebooks, mobile music players, mobile game machines, smart phones, and tablet personal computers, and electronic devices, such as displays for television sets and personal computers, the double-sided pressure-sensitive adhesive tape 10 according to the embodiment can be used for adhesively fixing various members or modules including: joining between a display (also, referred to as a window, lens, panel, display panel, transparent member of a display, or the like) to be provided on the surface of an image display module and a case; joining between touch panel members; and joining between LCD members.

### EXAMPLES

Hereinafter, examples, etc., in which the structures and effects of the present embodiment are specifically indicated, will be described, but the present invention should not be limited to these examples.

### Example 1

### Preparation of Acrylic Polymer

Three parts by mass of acrylic acid, 70 parts by mass of acrylic acid butyl, 27 parts by mass of acrylic acid 2-ethylhexyl, and 135 parts by mass of toluene as a polymerization solvent, were placed into a reaction vessel provided with a stirrer, reflux condenser, thermometer, dropping device, and nitrogen inlet pipe, and they were stirred for 2 hours while a nitrogen gas was being introduced. After the oxygen in the polymerization system was removed in this way, 0.1 parts by mass of AIBN (2,2′-azobisisobutyronitrile) were added thereto and they were heated to 60° C. such that a polymerization reaction was performed for 6 hours at the temperature. The solid content of the obtained polymer (acrylic polymer) was 40.5% and the weight average molecular weight thereof was 400,000.

### (Preparation of Acrylic Oligomer)

Cyclohexyl methacrylate (95 parts by mass), acrylic acid (5 parts by mass), α-methylstyrene dimer (product name: “Nofiner MSD”, made by NOF CORPORATION, 10 parts by mass), AIBN (2,2′-azobisisobutyronitrile) (10 parts by mass), and toluene (120 parts by mass) as a polymerization solvent, were placed into a reaction vessel provided with a stirrer, reflux condenser, thermometer, dropping device, and nitrogen inlet pipe, and they were stirred for 1 hour while a nitrogen gas was being introduced. After the oxygen in the polymerization system was removed in this way, they were heated to 85° C. such that they were reacted together for 5 hours, thereby allowing an acrylic oligomer having a solid content of 50% to be obtained. The weight average molecular weight of the obtained acrylic oligomer was 4300.

One hundred parts by mass of the acrylic polymer as a major polymer and 10 parts by mass of the acrylic polymer as an additive were added and sufficiently stirred until the additive was dissolved, thereby allowing a preparative pressure-sensitive adhesive solution to be obtained. To this preparative pressure-sensitive adhesive solution, 1 part by mass of an aromatic polyisocyanate (product name: “CORONATE L”, made by NIPPON POLYURETHANE INDUSTRY CO., LTD., solid content: 75%), which is isocyanate-based, and 0.01 parts by mass of 1,3-bis(N,N-diglycidyl aminomethyl cyclohexane (product name: “TETRAD C”, made by NIPPON POLYURETHANE INDUSTRY CO., LTD.), which is epoxy-based, were added as cross-linking agents, and they were sufficiently stirred to obtain a pressure-sensitive adhesive solution (pressure-sensitive adhesive A). A pressure-sensitive adhesive layer 1 whose dried coating thickness was 69 μm was coated on one surface of a paper separator (made by NITTO DENKO CORPORATION, thickness: 135 μm) by using this pressure-sensitive adhesive A, and dried at 100° C. for 2 minutes, the one surface being subjected to a silicon treatment. A film substrate made of a polyethylene terephthalate resin (product name: “Lumirror #12”, made by Toray Industries, Inc., thickness: 12 μm) was attached to this pressure-sensitive adhesive layer surface to obtain a process product 1.

A pressure-sensitive adhesive layer 2 whose dried coating thickness was 69 μm was coated on one surface of a paper separator (made by NITTO DENKO CORPORATION, thickness: 135 μm) by using the aforementioned pressure-sensitive adhesive A, and dried at 100° C. for 2 minutes, the one surface being subjected to a silicon treatment. This pressure-sensitive adhesive layer surface and the PET substrate surface of the aforementioned process product 1 were attached together to produce a double-sided pressure-sensitive adhesive tape having a total thickness of 150 μm. The obtained double-sided pressure-sensitive adhesive tape was aged under a 50° C. atmosphere for 24 hours to be evaluated.

### Example 2

A double-sided pressure-sensitive adhesive tape having a total thickness of 200 μm was produced in the same way as in Example 1, except that the pressure-sensitive adhesive A was coated on each surface of a film substrate such that a dried coating thickness became 94 μm.

### Example 3

A double-sided pressure-sensitive adhesive tape having a total thickness of 200 μm was produced in the same way as in Example 1, except that the pressure-sensitive adhesive A was coated on each surface of a film substrate made of a polyethylene terephthalate resin (product name: “Lumirror #25”, made by Toray Industries, Inc., thickness: 25 μm), which was used as a substrate, so that a dried coating thickness became 87.5 μm.

### Example 4

A double-sided pressure-sensitive adhesive tape having a total thickness of 50 μm was produced in the same way as in Example 1, except that the pressure-sensitive adhesive A was coated on each surface of the film substrate such that a dried coating thickness became 19 μm.

### Example 5

A double-sided pressure-sensitive adhesive tape having a total thickness of 100 μm was produced in the same way as in Example 1, except that the pressure-sensitive adhesive A was coated on each surface of a film substrate made of a polyethylene terephthalate resin (product name: “Lumirror #4”, made by Toray Industries, Inc., thickness: 4 μm), which was used as a substrate, so that a dried coating thickness became 48 μm.

### Example 6

A double-sided pressure-sensitive adhesive tape having a total thickness of 150 μm was produced in the same way as in Example 1, except that the pressure-sensitive adhesive A was coated on each surface of a film substrate made of a polyethylene terephthalate resin (product name: “Lumirror #50”, made by Toray Industries, Inc., thickness: 50 μm), which was used as a substrate, so that a dried coating thickness became 50 μm.

### Comparative Example 1

A double-sided pressure-sensitive adhesive tape having a total thickness of 200 μm was produced in the same way as in Example 2, except that a pressure-sensitive adhesive B was used, the pressure-sensitive adhesive B being produced by adding 40.5 parts by mass of terpene modified phenol (product name: “SUMILITE RESIN”, made by SUMITOMO BAKELITE CO., LTD., solid content: 100%) as a tackifier, instead of a cyclohexyl methacrylate-acrylic acid copolymer that is used as an additive.

The structures of the aforementioned Examples and Comparative Example are collectively shown in Table 1.

TABLE 1

| | | EXAMPLE | EXAMPLE | EXAMPLE | EXAMPLE | EXAMPLE | EXAMPLE | COMPARATIVE |
|---|---|---|---|---|---|---|---|---|
| | | 1 | 2 | 3 | 4 | 5 | 6 | EXAMPLE 1 |
| STRUCTURE | PRESSURE- | 69 μm | 94 μm | 87.5 μm | 19 μm | 48 μm | 50 μm | 94 μm |
| | SENSITIVE | | | | | | | |
| | ADHESIVE | | | | | | | |
| | LAYER 1 | | | | | | | |
| | SUBSTRATE | 12 μm | 12 μm | 25 μm | 12 μm | 4 μm | 50 μm | 12 μm |
| | PRESSURE- | 69 μm | 94 μm | 87.5 μm | 19 μm | 48 μm | 50 μm | 94 μm |
| | SENSITIVE | | | | | | | |
| | ADHESIVE | | | | | | | |
| | LAYER 2 | | | | | | | |

| | | | | | | | |
|---|---|---|---|---|---|---|---|
| TOTAL THICKNESS | 150 μm | 200 μm | 200 μm | 50 μm | 100 μm | 150 μm | 200 μm |
| SUBSTRATE THICKNESS/ | 8.0% | 6.0% | 12.5% | 24.0% | 4.0% | 30.0% | 6.0% |
| TOTAL THICKNESS | | | | | | | |

Herein, the pressure-sensitive adhesive layer 1 represents a pressure-sensitive adhesive layer provided on one surface of a substrate (film substrate), while the pressure-sensitive adhesive layer 2 represents a pressure-sensitive adhesive layer provided on the other surface of the substrate. The “Substrate Thickness/Total Thickness” represents the ratio of a substrate thickness to a total thickness.

The double-sided pressure-sensitive adhesive tapes obtained above were evaluated in the following evaluation tests.

### [Drop Impact Resistance]

FIGS. 2A and 2B are schematic views of an evaluation sample to be used in evaluating impact resistance, in which: FIG. 2A is a plan view of the evaluation sample; and FIG. 2B is a sectional view, taken along Y-Y Line in FIG. 2A. Hereinafter, the procedures for evaluating impact resistance will be described with reference to FIGS. 2A and 2B.

The double-sided pressure-sensitive adhesive tape obtained in each of Examples and Comparative Example was first cut into a window frame-shaped (frame-shaped) piece having a width of 1 mm (40.0 mm in transverse length×60.0 mm in longitudinal length) to obtain a window frame-shaped double-sided pressure-sensitive adhesive tape 32. Subsequently, with the window frame-shaped double-sided pressure-sensitive adhesive tape 32, a polycarbonate lens 33 (40.0 mm in width×60.0 mm in length×1 mm in thickness, weight: 2.8 g) and a polycarbonate case 31 (PC case: 80.0 mm in width×70.0 mm in length×2 mm in thickness) were pressure-attached together by reciprocating a 2-kg roller once. Subsequently, a 94-g weight 34 (SUS plate) was attached to the polycarbonate lens 33, thereby producing an evaluation sample (total weight: 110 g).

Evaluation of impact resistance was performed by repeating free fall of the produced evaluation sample onto a concrete plate from a 1.5-m height under a normal temperature atmosphere (25° C.) and a low temperature atmosphere (−5° C.). In the evaluation of impact resistance under a normal temperature atmosphere (25° C.), the evaluation sample was dropped onto a concrete plate from a 120-cm height (maximum 18 times) after being aged for 1 hour. When the polycarbonate lens 33 was not peeled from the evaluation sample under a normal temperature atmosphere (25° C.), the evaluation of impact resistance was performed under a low temperature (−5° C.) (maximum 60 times) after being further aged at −5° C. for 30 minutes.

The number of times of free fall before the polycarbonate lens 33 was peeled from the polycarbonate case 31 is shown in Table 2. The “>X times” indicates that the polycarbonate lens 33 was not peeled from the polycarbonate case 31 when the free fall were repeated X times.

### [Level-Difference Followability (Waterproof Property)]

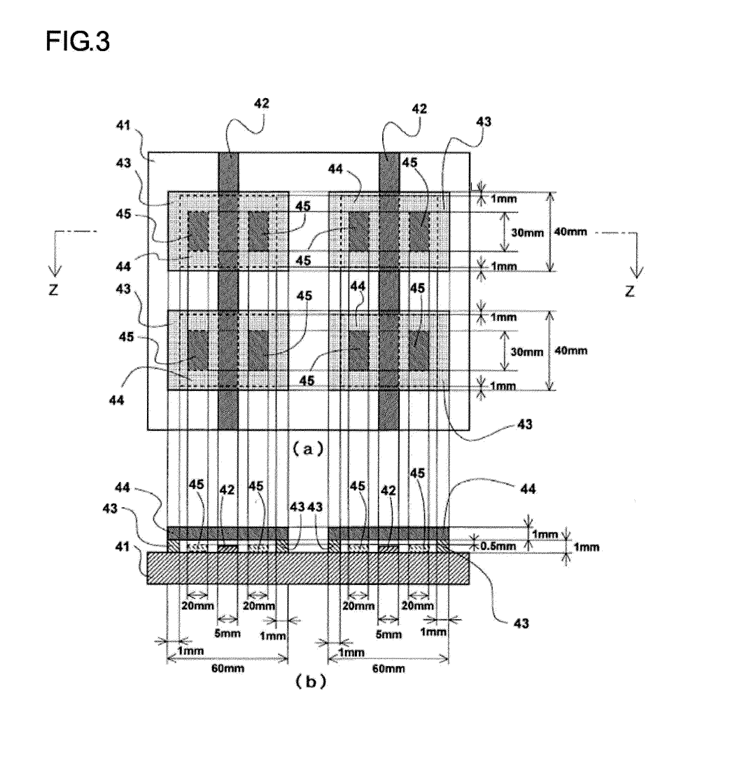

FIGS. 3A and 3B are schematic views of an evaluation sample to be used when level-difference followability (waterproof property) is evaluated, in which: FIG. 3A is a plan view of the evaluation sample; and FIG. 3B is a sectional view, taken along Z-Z Line in FIG. 3A. Hereinafter, the procedures for evaluating level-difference followability with reference to FIGS. 3A and 3B.

The double-sided pressure-sensitive adhesive tape obtained in each of Examples and Comparative Example was first cut into a frame-shaped (window frame-shaped) piece having a width of 1 mm (40.0 mm in transverse length×60.0 mm in longitudinal length) to obtain a frame-shaped double-sided pressure-sensitive adhesive tape 43. Subsequently, the frame-shaped double-sided pressure-sensitive adhesive tapes 43 were attached to four acrylic plates (acrylic lenses) 44 (40.0 mm in width×60.0 mm in length×1 mm in thickness), and as illustrated in FIGS. 3A and 3B, the four acrylic plates 44 to which the frame-shaped double-sided pressure-sensitive adhesive tapes 43 had been attached were then press-attached, by reciprocating a 2-kg roller once, to a polycarbonate plate 41 to which two level-difference tapes (width: 5 mm) had been attached, thereby allowing an evaluation sample for each concavo-convex height (10 μm, 20 μm, 30 μm, 50 μm, 70 μm, and 100 μm) to be obtained. Herein, the level-difference tapes 42 were attached in order to provide concavities and convexities on the polycarbonate plate 41, thereby allowing a target concavo-convex height to be obtained.

Similarly, the four acrylic plates 44 to which the double-sided pressure-sensitive adhesive tapes 43 had been attached were press-attached, by reciprocating a 2-kg roller once, to the polycarbonate plate 41 to which the two level-difference tapes 42 had not been attached and the surface of which was smooth, thereby also allowing an evaluation sample for a concavo-convex height of 0 μm (without a level difference).

Non-woven cloth 45 (35 mm in width×55 mm in length×0.05 mm in thickness), which has a character of changing its color when absorbing water, was arranged between the acrylic plate 44 and the polycarbonate plate 41 in each of the evaluation samples, for visual evaluation in which it was confirmed whether water entered the inside. The non-woven cloth 45 does not affect the test for evaluating level-difference followability (waterproof property).

According to IPX-7 standards (JIS C 0920/IEC 60529), a test for evaluating level-difference followability (waterproof property) was performed as follows. In a normal state (temperature: 23° C., humidity: 50% RH), an evaluation sample for each concavo-convex height was immersed in a water tank having a water depth of 1 m for 30 minutes, and it was confirmed whether water entered the inside. Herein, the evaluation sample was used in the evaluation test after being aged in the normal state (temperature: 23° C., humidity: 50% RH) for 30 minutes.

The level-difference followability (waterproof property) evaluation of a double-sided pressure-sensitive adhesive tape was performed by visually observing whether water entered the inside of each of eight samples (eight acrylic-plate-attached portions), the eight samples being obtained by preparing, for each concavo-convex height, two evaluation samples to which the four acrylic plates 44 had been attached. Results of evaluating level-difference followability are shown in Table 2. Of the samples having level-difference followability (waterproof property), that is, of the samples in which it is determined that water did not enter the inside, the sample having the largest concavo-convex height is shown in Table 2. A double-sided pressure-sensitive adhesive tape in which level-difference followability (waterproof property) was confirmed at a concavo-convex height of 30 μm or more was evaluated as good, while a double-sided pressure-sensitive adhesive tape in which level-difference followability (waterproof property) was confirmed only at a concavo-convex height of 5 μm or less was evaluated as bad.

### [Blocking Occurrence Time]

A double-sided pressure-sensitive adhesive tape was left uncontrolled after a frame-shaped piece of the tape, having the width of each side of 1 mm, was punched out, and a period of time before the punched-out double-sided pressure-sensitive adhesive tape and the surrounding portion were blocked (readhered) was measured. A period of time of 100 hours or longer indicates a good blocking occurrence time, while a period of time of 24 hours or shorter indicates a not good blocking occurrence time.

### [Workability]

It was studied whether a problem was caused when a double-sided pressure-sensitive adhesive tape, obtained by being punched out such that the width of each side was 1 mm, was attached to a case. “o” indicates the case where the tape was able to be attached without any deformation or stretch, while “x” indicates the case where the attachment was difficult due to a deformation or stretch.

TABLE 2

| | | | EXAMPLE | | EXAMPLE | | EXAMPLE | | EXAMPLE | | EXAMPLE | | EXAMPLE | | COMPARATIVE | |
|---|---|---|---|---|---|---|---|---|---|---|---|---|---|---|---|---|
| | | | 1 | | 2 | | 3 | | 4 | | 5 | | 6 | | EXAMPLE 1 | |
| DROP | 25° | C. | >18 | TIMES | >18 | TIMES | >18 | TIMES | >18 | TIMES | >18 | TIMES | >18 | TIMES | >18 | TIMES |
| IMPACT | −5° | C. | >60 | TIMES | >60 | TIMES | >60 | TIMES | >60 | TIMES | >60 | TIMES | 55 | TIMES | 2 | TIMES |
| RESIS- | | | | | | | | | | | | | | | | |
| TANCE | | | | | | | | | | | | | | | | |

| | | | | | | | | | | | | | | |
|---|---|---|---|---|---|---|---|---|---|---|---|---|---|---|
| LEVEL- | 30 | μm | 50 | μm | 30 | μm | 0 | μm | 50 | μm | 5 | μm | 50 | μm |
| DIFFERENCE | | | | | | | | | | | | | | |
| FOLLOWABILITY | | | | | | | | | | | | | | |

| | | | | | | | | |
|---|---|---|---|---|---|---|---|---|
| BLOCKING | 150 HOURS | 150 HOURS | 150 HOURS | 150 HOURS | 24 | HOURS | 150 HOURS | 150 HOURS |
| OCCURRENCE | OR LONGER | OR LONGER | OR LONGER | OR LONGER | | | OR LONGER | OR LONGER |
| TIME | | | | | | | | |

| | | | | | | | |
|---|---|---|---|---|---|---|---|
| WORKABILITY | ◯ | ◯ | ◯ | ◯ | X | ◯ | ◯ |

In the double-sided pressure-sensitive adhesive tape according to each of Examples 1 to 5, the drop impact resistance at −5° C. was good. Further, in the double-sided pressure-sensitive adhesive tape according to each of Examples 1 to 3 in which the ratio of the substrate to the thickness (total thickness) of the tape was within a range of 5 to 20%, all of the blocking occurrence time, the workability, and the level-difference followability were good, in addition to the drop impact resistance at −5° C.

On the other hand, in the double-sided pressure-sensitive adhesive tape according to Comparative Example 1, the drop impact resistance in a low-temperature atmosphere (−5° C.) was remarkably smaller than that of the double-sided pressure-sensitive adhesive tape according to each of Examples 1 to 3. That is, it has been confirmed, from the comparison between Examples 1 to 6 and Comparative Example 1, that the drop impact resistance of a double-sided pressure-sensitive adhesive tape in a low-temperature atmosphere can be remarkably improved by adding, as an additive, an oligomer to a pressure-sensitive adhesive.

The present invention should not be limited to the aforementioned embodiments, and various modifications, such as design modifications, can be made with respect to the above embodiments based on the knowledge of those skilled in the art, and an embodiment with such a modification can fall within the scope of the present invention.

What is claimed is:

1. A double-sided pressure-sensitive adhesive tape to be used for fixing members of electronic devices, comprising:
a substrate;
a first pressure-sensitive adhesive layer provided on one surface of the substrate; and
a second pressure-sensitive adhesive layer provided on the other surface of the substrate, wherein
at least one of the first pressure-sensitive adhesive layer and the second pressure-sensitive adhesive layer contains both an acrylic polymer and an acrylic oligomer whose weight average molecular weight is 20000 or less and whose monomer is different from that of the acrylic polymer.

2. The double-sided pressure-sensitive adhesive tape according to claim 1, wherein
the content of a tackifier in at least one of the first pressure-sensitive adhesive layer and the second pressure-sensitive adhesive layer is less than 5% by mass.

3. The double-sided pressure-sensitive adhesive tape according to claim 1, wherein
the thickness of the substrate is 5 to 20% relative to that of the double-sided pressure-sensitive adhesive tape.

4. The double-sided pressure-sensitive adhesive tape according to claim 1, wherein
the content of the acrylic oligomer is 1 to 50 parts by mass, based on 100 parts by mass of the acrylic polymer.

5. The double-sided pressure-sensitive adhesive tape according to claim 1, wherein
the substrate is a plastic film.

6. The double-sided pressure-sensitive adhesive tape according to claim 2, wherein
the thickness of the substrate is 5 to 20% relative to that of the double-sided pressure-sensitive adhesive tape.

7. The double-sided pressure-sensitive adhesive tape according to claim 2, wherein
the content of the acrylic oligomer is 1 to 50 parts by mass, based on 100 parts by mass of the acrylic polymer.

8. The double-sided pressure-sensitive adhesive tape according to claim 3, wherein
the content of the acrylic oligomer is 1 to 50 parts by mass, based on 100 parts by mass of the acrylic polymer.

9. The double-sided pressure-sensitive adhesive tape according to claim 6, wherein
the content of the acrylic oligomer is 1 to 50 parts by mass, based on 100 parts by mass of the acrylic polymer.

10. The double-sided pressure-sensitive adhesive tape according to claim 2, wherein
the substrate is a plastic film.

11. The double-sided pressure-sensitive adhesive tape according to claim 3, wherein
the substrate is a plastic film.

12. The double-sided pressure-sensitive adhesive tape according to claim 6, wherein
the substrate is a plastic film.
